(19) United States
(12) Patent Application Publication
(10) Pub. No.: US 2013/0246004 A1
(43) Pub. Date: Sep. 19, 2013

(54) AUTOMATIC PARTICLE MEASUREMENT CART AND AUTOMATIC PARTICLE MEASUREMENT SYSTEM FOR CLEAN ROOM AND MEASUREMENT METHOD THEREOF

(71) Applicants: Minghu Qi, Shenzhen (CN); Chun Hao Wu, Shenzhen (CN); Kun Hsien Lin, Shenzhen (CN); Yongqiang Wang, Shenzhen (CN); Erqing Zhu, Shenzhen (CN); Xiande Li, Shenzhen (CN)

(72) Inventors: Minghu Qi, Shenzhen (CN); Chun Hao Wu, Shenzhen (CN); Kun Hsien Lin, Shenzhen (CN); Yongqiang Wang, Shenzhen (CN); Erqing Zhu, Shenzhen (CN); Xiande Li, Shenzhen (CN)

(73) Assignee: Shenzhen China Star Optoelectronics Technology Co. Ltd., Guangdong (CN)

(21) Appl. No.: 13/510,388

(22) PCT Filed: Apr. 6, 2012
(86) PCT No.: PCT/CN12/73569

§ 371 Date: May 17, 2012

(30) Foreign Application Priority Data
Mar. 15, 2012 (CN) 201210068824.3

(51) Int. Cl. G06F 15/00

(52) U.S. Cl. 702/188

(57) ABSTRACT

The present invention discloses an automatic particle measurement cart and an automatic particle measurement system for clean room and a measurement method thereof. The automatic measurement cart includes an automatic piloting device, which guides the cart to move along a pre-set path. The automatic piloting device includes a reading head, which recognizes the pres-set detective path and detects multiple pre-set measurement points. The cart moves along the detective path. A measurement device measures particles at the measurement points. A data processing device receives particle data measured by the measurement device and provides output according to a pre-set rule. With the above manner, the present invention can automatically measure clean room particles at a given site so as to reduce human labor involved and improve the preciseness of measurement result.

### BACKGROUND OF THE INVENTION

1. Field of the Invention

The present invention relates to the field of measurement, and in particular to an automatic particle measurement cart and automatic particle measurement system for clean room and a measurement method thereof.

2. The Related Arts

The requirement for manufacturing environment is getting increasingly severe, especially for a clean room that requires an extremely clean environment. Particle measurement of clean room is often taken as a condition for the assessment of the environment. Conventionally, particle measurement of clean room is done manually. Referring to FIG. 1, FIG. 1 shows a measurement scene in which particle measurement of clean room is conducted in a conventional way. In a clean room 102, multiple machines 104 are installed. A measurement point 103 is set up at a location close to each machine 104. Conventionally, a measurement device 101 is manually operated to conduct measurement at the measurement point 103 and the data measured indicate “particle data” of the clean room 102. Since the measurement operation is conducted manually, the result of measurement is directly subjected to the influence of the operator. Consequently, certain problems may arise, including irregular performance of measurement, excessive error of measurement data, or delay of processing data obtained by the measurement operators. Apparently, manual measurement cannot meet the current needs of measurement.

### SUMMARY OF THE INVENTION

The primary technical issue to be addressed by the present invention is to provide an automatic particle measurement cart and automatic particle measurement system for clean room and a measurement method thereof, which automatically conduct measurement of particles of a designated site of a clean room, whereby human resources in this respect can be reduced and the preciseness of measurement result can be improved.

To address the above technical issue, the present invention adopts a technical solution by providing an automatic particle measurement cart for clean room. The cart comprises: an automatic piloting device, which guides the cart to move along a pre-set path, the automatic piloting device comprising a reading head, the reading head functioning to recognize a pre-set detective path and identify a plurality of pre-set measurement points, the cart being movable along the pre-set detective path; a measurement device, which measures particles at the measurement points; and a data processing device, which transmits the measured particle data to the data processing device, the data processing device making output of data according to a pre-set rule.

Wherein, the reading head comprises an electromagnetic sensor, a laser sensor, a magnet-gyro sensor, or a vision-guided sensor.

Wherein, the cart further comprises a movement suspension device, wherein the movement suspension device carries out control for suspension of movement when the reading head detects and identifies the measurement points or when the cart reaches pre-loaded measurement points, so that the measurement device measures particles at the measurement points.

Wherein, the data processing device is pre-loaded with data of measurement point, the data of measurement point comprising one or more of the following data: time interval for carrying out a next automatic measurement operation after completion of a previous measurement operation, time interval for actively carrying out a next automatic measurement operation after identification of abnormal data, positional relationship of spaced measurement points, and acceptable range of particle number.

Wherein, the cart further comprises an instruction input device, wherein the instruction input device receives an instruction of initiating an automatic measurement operation and activates the cart to carry out the automatic measurement operation.

Wherein, the data processing device is pre-loaded with an operation instruction for data abnormality, the instruction being such that when the measured data are normal, a next automatic measurement operation is carried out according to the time interval for automatic measurement and when the measured data are abnormal, a next measurement operation is initiated according to the time interval for automatic measurement for data abnormality or an automatic measurement operation is initiated according to an input instruction from the input device.

Wherein, the cart further comprises a storage battery and an automatic charging device to supply power for movement to the cart.

To address the above technical issue, the present invention adopts another technical solution by providing an automatic particle measurement system for clean room, and the system comprises the automatic particle measurement cart for clean room described above and a detective strip corresponding to the reading head and mounted on ground of a measured space.

Wherein, the measurement points set up at predetermined locations on the detective strip have detection power greater than that of surrounding sites.

To address the above technical issue, the present invention adopts a further technical solution by providing a method for automatic measurement of clean room particle, and the method comprises the following steps:

storing step: in which data of measurement point are stored in advance, the data of measurement point comprising one or more of the following data: time interval for carrying out a next automatic measurement operation after completion of a previous measurement operation, time interval for actively carrying out a next automatic measurement operation after identification of abnormal data, positional relationship of spaced measurement points, and acceptable range of particle number;

moving step: in which guidance through electromagnetic sensing, laser sensing, magnet-gyro sensing, or vision-guided sensing is employed to detect and recognize pre-set detective path and measurement points and movement is made along the detective path;

measuring step: in which when a measurement point is detected and recognized, the movement is suspended to carry out measurement of particle at the measurement point, or when movement is made to reach a pre-determined measurement point, the movement is suspended to carry out measurement of particles of the measurement point;

transmitting step: in which multiple particle data measured by the measurement device are transmitted; and processing step: in which the multiple particle data are received and processed.

Wherein, the storing step further comprises storing an operation instruction for data abnormality, the instruction being such that when the measured data are normal, a next automatic measurement operation is carried out according to the time interval for automatic measurement and when the measured data are abnormal, a next measurement operation is initiated according to the time interval for automatic measurement for data abnormality or the cart is activated to initiate an automatic measurement operation upon receipt of an input instruction for initiating automatic measurement.

Wherein, the processing of multiple particle data further comprises: outputting multiple particle data according to a pre-set rule.

Wherein, the pre-set rule comprises outputting each particle data upon receiving the individual particle data or collectively outputting all the particle data after completely receiving all the particle data.

The efficacy of the present invention is that the present invention provides an automatic measurement cart that comprises an automatic piloting device, a measurement device, and a data processing device to move along a predetermined path and carry out automatic measurement of particles at a measurement point and also to process and output the measured particle data. With the above described manner, the present invention can automatically measure clean room particles at a given site so as to reduce human labor involved and improve the preciseness of measurement result.

### BRIEF DESCRIPTION OF THE DRAWINGS

FIG. 1 shows a measurement scene in which particle measurement of clean room is conducted in a conventional way;

FIG. 2 is a block diagram illustrating a structure of automatic particle measurement cart for clean room according to an embodiment of the present invention;

FIG. 3 is a flow chart illustrating a method for measuring clean room particle according to an embodiment of the present invention; and

FIG. 4 shows a measurement scene in which the method for measuring clean room particle according to FIG. 3 is conducted.

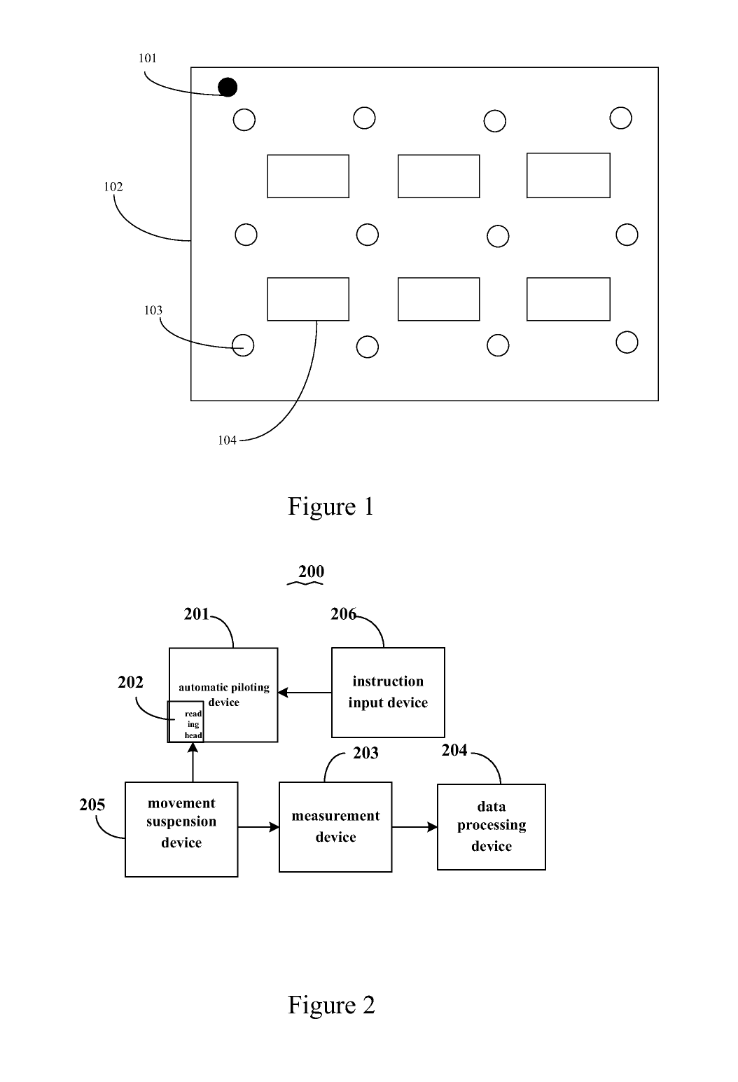

### DETAILED DESCRIPTION OF THE PREFERRED EMBODIMENTS

Referring to FIG. 2, FIG. 2 is a block diagram illustrating a structure of automatic particle measurement cart for clean room according to an embodiment of the present invention. The automatic particle measurement cart 200 for clean room according to the instant embodiment comprises: an automatic piloting device 201, a measurement device 203, and a data processing device 204, and may further comprise a movement suspension device 205 and an instruction input device 206. The automatic piloting device 201 comprises a reading head 202.

In the instant embodiment, the automatic piloting device 201 pilots the cart to move along a predetermined path. The measurement device 203 measures particles at a measurement point and transmits the measured particle data to the data processing device 204. The data processing device 204 makes a determination on the data and makes an output of data according to a predetermined rule. The data processing device 204 is also loaded, in advance, data of measurement points and operation instructions for data abnormality. The movement suspension device 205 may function to control the cart for suspending the movement thereof. The instruction input device 206 may function to receive a manual input of instruction for starting automatic measurement and activating the cart to carry out an automatic measurement operation.

Functions of the various devices will be description by illustrating the operation principle of the automatic measurement cart 200. In the instant embodiment, the reading head 202 recognizes a pre-set detective path and identifies multiple pre-set measurement points. The cart moves by following the detective path recognized by the reading head 202. The movement suspension device 205 is operated to pause the cart when the reading head 202 identifies a measurement point or when the cart reaches a measurement point that is previously loaded in the data processing device 204 to allow the measurement device 203 to measure particles at the measurement point and transmit the measured particle data to the data processing device 204. The data processing device 204 first determines if the measured particle data exceeds a particle data limit according to a pre-loaded threshold and then transmits the data in a wireless manner.

The cart moves by following a pre-set detective path and the measurement device sequentially takes measurements of the particles at the multiple measurement points. After the measurement operation is completed, processing may be carried out according to the result of determination. Specifically, when identifying no data exceeds the pre-set particle data limit, the data processing device 204 determines that the measured data are normal and accesses the next scheduled time of automatic measurement that is pre-loaded to issue an instruction for initiating an automatic measurement operation according to the scheduled time. When identifying data exceed the pre-set particle data limit, the data processing device 204 determines that the measured data are abnormal and access the pre-set next scheduled time of automatic measurement for situation of data abnormality identified and issue an instruction for initiating an automatic measurement operation according to the scheduled time.

In another way of practice, if the data processing device 204 is not pre-loaded with a scheduled time of automatic measurement for situation of data abnormality identified, then once data abnormality is identified, the next automatic measurement can be carried out at the same scheduled time as the case when measured data are determined to be normal. Or alternatively, when data are abnormal, it is feasible to wait for a manual input of initiating an automatic measurement operation received through the instruction input device in order to activate the cart to carry out the automatic measurement operation.

The cart may further comprise a storage battery that supplies power for movement and an automatic charging device.

In the instant embodiment, the reading head 202 is preferably an electromagnetic sensor, a laser sensor, a magnet-gyro sensor, or a vision-guided sensor. The pre-set rule that the data processing device 204 follows to output data may be such that data are individually output once received or all the data are collectively output after they are all completely received. The measurement points that are pre-set in the data processing device 204 can be equally spaced in either time or distance. The particle data limit that is pre-set in the data processing device 204 is determined according to the requirement of the clean room.

The present invention also provides an automatic particle measurement system for clean room. The system comprises the automatic measurement cart for clean room shown in FIG. 2 and a detective strip mounted on the ground of a measured space and corresponding to the reading head of the cart. Specifically, when the reading head is an electromagnetic sensor or a magnet-gyro sensor, the detective strip can be a magnetic strip. When the reading head is a vision-guided sensor, the detective strip is a strip that shows a sharp vision effect with respect to the surroundings, such as a black strip. When the reading head is a laser sensor, the strip is a strip that can be recognized by laser beam. The path of the detective strip is determined according to a practical situation desired. The cart may move along the detective strip.

The embodiment of FIG. 2 gives two example ways of setting up the measurement points, of which one is to load pre-set measurement points in the data processing device 204 and the other is to allow the reading head to identify pre-set measurement points. The reading head may identify or recognize the measurement points that are arranged on the detective strip for the detection power with respect to the measurement points are set greater than that with respect to other portions of the detective strip.

The locations and the number of the measurement points are determined according to the practical need.

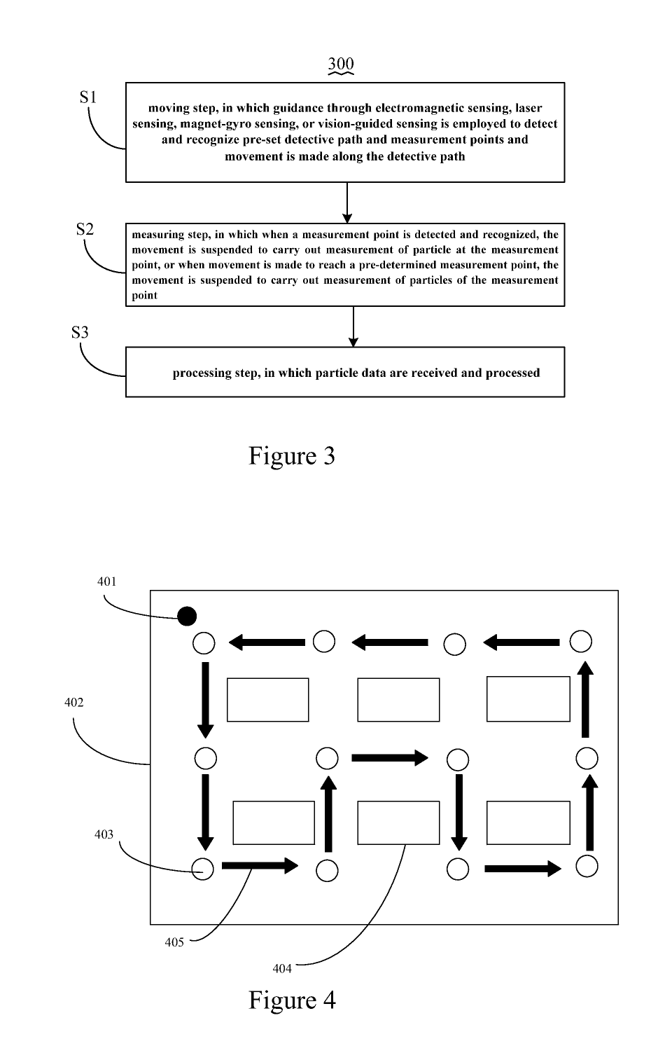

Referring to FIG. 3, FIG. 3 is a flow chart illustrating a method for measuring clean room particle according to an embodiment of the present invention. As shown in FIG. 3, the measurement method 300 comprises the following steps:

S1: moving step, in which guidance through electromagnetic sensing, laser sensing, magnet-gyro sensing, or vision-guided sensing is employed to detect and recognize pre-set detective path and measurement points and movement is made along the detective path.

S2: measuring step, in which when a measurement point is detected and recognized, the movement is suspended to carry out measurement of particle at the measurement point, or when movement is made to reach a pre-determined measurement point, the movement is suspended to carry out measurement of particles of the measurement point.

S3: processing step, in which particle data are received and processed.

Referring to FIG. 4, FIG. 4 shows a measurement scene in which the method for measuring clean room particle according to FIG. 3 is conducted. As shown in FIG. 4, the cart 401 comprises an automatic piloting device, a measurement device, and a data processing device. Firstly, a detective path 405 and measurement points 403 are manually set up in a space of clean room 402. The detective path 405 is set up along a perimeter of a machine 404 and the measurement points 403 are set up on the detective path 405. The reading head recognizes the detective path 405, and the cart 401 moves along the recognized detective path 405. When the reading head of the cart detect and identify a measurement point 403, the movement of the cart is suspended and the measurement device conducts measurement of particles at the measurement point 403 and transmits the measurement data to the data processing device. The data processing device receives and processes the data. The specific way of processing is similar to that discussed with reference to the data processing device of FIG. 2 and repeated description will be omitted herein.

In summary, the present invention provides an automatic measurement cart that comprises an automatic piloting device, a measurement device, and a data processing device to carry out automatic measurement of particles at a measurement point and also to process and output the measured particle data. With the above described manner, the present invention can automatically measure clean room particles at a given site so as to reduce human labor involved and improve the preciseness of measurement result.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. An automatic particle measurement cart for clean room, characterized by comprising:
an automatic piloting device, which guides the cart to move along a pre-set path, the automatic piloting device comprising a reading head, the reading head functioning to recognize a pre-set detective path and identify a plurality of pre-set measurement points, the cart being movable along the pre-set detective path;
a measurement device, which measures particles at the measurement points; and
a data processing device, which transmits the measured particle data to the data processing device, the data processing device making output of data according to a pre-set rule.

2. The automatic particle measurement cart for clean room as claimed in claim 1, characterized in that the reading head comprises an electromagnetic sensor, a laser sensor, a magnet-gyro sensor, or a vision-guided sensor.

3. The automatic particle measurement cart for clean room as claimed in claim 1, characterized by further comprising a movement suspension device, wherein the movement suspension device carries out control for suspension of movement when the reading head detects and identifies the measurement points or when the cart reaches pre-loaded measurement points, so that the measurement device measures particles at the measurement points.

4. The automatic particle measurement cart for clean room as claimed in claim 1, characterized in that the data processing device is pre-loaded with data of measurement point, the data of measurement point comprising one or more of the following data: time interval for carrying out a next automatic measurement operation after completion of a previous measurement operation, time interval for actively carrying out a next automatic measurement operation after identification of abnormal data, positional relationship of spaced measurement points, and acceptable range of particle number.

5. The automatic particle measurement cart for clean room as claimed in claim 4, characterized by further comprising an instruction input device, wherein the instruction input device receives an instruction of initiating an automatic measurement operation and activates the cart to carry out the automatic measurement operation.

6. The automatic particle measurement cart for clean room as claimed in claim 5, characterized in that the data processing device is pre-loaded with an operation instruction for data abnormality, the instruction being such that when the measured data are normal, a next automatic measurement operation is carried out according to the time interval for automatic measurement and when the measured data are abnormal, a next measurement operation is initiated according to the time interval for automatic measurement for data abnormality or an automatic measurement operation is initiated according to an input instruction from the input device.

7. The automatic particle measurement cart for clean room as claimed in claim 5, characterized by further comprising a storage battery and an automatic charging device to supply power for movement to the cart.

8. An automatic particle measurement system for clean room, characterized by comprising the automatic particle measurement cart for clean room as claimed in claim 1 and a detective strip corresponding to the reading head and mounted on ground of a measured space.

9. The automatic particle measurement system for clean room as claimed in claim 8, characterized in that the measurement points set up at predetermined locations on the detective strip have detection power greater than that of surrounding sites.

10. A method for automatic measurement of clean room particle, characterized by comprising the following steps:
storing step: in which data of measurement point are stored in advance, the data of measurement point comprising one or more of the following data: time interval for carrying out a next automatic measurement operation after completion of a previous measurement operation, time interval for actively carrying out a next automatic measurement operation after identification of abnormal data, positional relationship of spaced measurement points, and acceptable range of particle number;
moving step: in which guidance through electromagnetic sensing, laser sensing, magnet-gyro sensing, or vision-guided sensing is employed to detect and recognize pre-set detective path and measurement points and movement is made along the detective path;
measuring step: in which when a measurement point is detected and recognized, the movement is suspended to carry out measurement of particle at the measurement point, or when movement is made to reach a pre-determined measurement point, the movement is suspended to carry out measurement of particles of the measurement point;
transmitting step: in which multiple particle data measured by the measurement device are transmitted; and
processing step: in which the multiple particle data are received and processed.

11. The method for automatic measurement of clean room particle as claimed in claim 10, characterized in that
the storing step further comprises storing an operation instruction for data abnormality, the instruction being such that when the measured data are normal, a next automatic measurement operation is carried out according to the time interval for automatic measurement and when the measured data are abnormal, a next measurement operation is initiated according to the time interval for automatic measurement for data abnormality or the cart is activated to initiate an automatic measurement operation upon receipt of an input instruction for initiating automatic measurement.

12. The method for automatic measurement of clean room particle as claimed in claim 10, characterized in that the processing of multiple particle data further comprises: outputting multiple particle data according to a pre-set rule.

13. The method for automatic measurement of clean room particle as claimed in claim 12, characterized in that the pre-set rule comprises outputting each particle data upon receiving the individual particle data or collectively outputting all the particle data after completely receiving all the particle data.
